(19) United States
(12) Patent Application Publication
(10) Pub. No.: US 2006/0168285 A1
(43) Pub. Date: Jul. 27, 2006

(54) File upload using a browser

(76) Inventors: Peter D. Nielsen, Kgs. Lyngby (DK); Christian Kraft, Frederiksberg C (DK)

Correspondence Address: HARRINGTON & SMITH, LLP, 4 RESEARCH DRIVE, SHELTON, CT, 06484-6212, US

(21) Appl. No.: 10/547,497

(22) PCT Filed: Apr. 17, 2003
(86) PCT No.: PCT/IB03/01937

§ 371 Date: Aug. 31, 2005

(51) Int. Cl. G06F 15/16

(52) U.S. Cl. 709/231

(57) ABSTRACT

A method of uploading data to a server 9n the Internet using a browser application. The browser application interprets received mark-up data identifying a first server for data upload and provides at least a first user selectable option for upload of pre-recorded data and a second user selectable option for upload of contemporaneous data. In response to user selection of the first option, the browser application enables the user selection and upload of pre-recorded data to the first server. (n response to user selection of the second option, the browser), D application enables the capture and upload of contemporaneous second data.

### BACKGROUND OF THE INVENTION

Embodiments of the present invention relate to file upload to a server using a browser application of a client. In particular, they relate to the upload of a file contemporaneously created for upload.

A browser is a computer program that accesses and displays data available on the Internet and other networks. A current browser may interpret Hypertext mark-up Language (HTML) to produce a document containing cross-references or “links” which, allow a user to navigate easily from one document to another.

A web-page may use the following HTML code to allow a user to upload a file to a server at the web-page “url” as part of a form input.

<form enctype= “multipart/form-data” method= “post” action= “url” >
<p>
Please upload a file: <br>
<input type= “file” name= “file” >
</p>
<p>
<input type= “submit” value=”send”>
</p>
</form>

A browser in a client interprets the HTML code and produces a file widget in a graphical user interface as illustrated in FIG. 1.

The user either enters the path of the file to be uploaded in the text entry field 2 or selects the browse button 4 and then locates and selects the desired file in a file manager application, which will automatically enter the path of the selected file in the text entry field 2. The user then selects the Send button 6 to upload the file.

If a user wishes to upload a contemporaneous camera image or audio recording, the user must first create and store the contemporaneous camera image or audio recording as a file and then separately upload the stored file.

### BRIEF DESCRIPTION OF THE INVENTION

It would be desirable to improve the ease with which a user can upload information using a browser. In particular, it would be desirable to improve the process of uploading a contemporaneous camera image, audio recording to the like.

According to one aspect of the present invention there is provided a device for accessing a remote network and for uploading data to a server of the network, comprising: an interface for communicating with the remote network;

a memory; means for interpreting mark-up data received from the network identifying a first server for data upload and for providing a first user option of uploading pre-recorded data from the memory to the first server and a second user option of capturing and uploading contemporaneous second data to the first server.

Embodiments of the invention not only provide the user with a first option of uploading pre-recorded data from the memory to the server, but additionally provide the user with a second option of capturing and uploading contemporaneous data to the server. The user is therefore given an extra choice of uploading contemporaneously captured data as well as uploading pre-stored data.

Thus a user can upload captured data without having to pre-store it first in the memory so that it can then be uploaded using the first option of uploading pre-recorded data from the memory. The user can therefore more easily upload data captured for upload.

A user need not separately create a file and select the file for upload. The five stage process of taking a picture, saving the picture to a file system, choosing upload, selecting the file for upload and uploading the file may be reduced in some embodiments of the invention to the three steps of choosing upload, choosing the second option of uploading contemporaneous data and capturing the data.

In a preferred embodiment, the device further comprises a processor, a browser application; and a user interface including a display and at least one user input device, wherein the browser application interprets the mark-up data received from the network identifying a first server for data upload and provides, via a graphical user interface on the display, the first and second user options for user selection.

According to another aspect of the present invention there is provided a method of uploading data to a server of a network, comprising, in a browser application, the steps of: receiving mark-up data identifying a first server for data upload; interpreting the received mark-up data to provide at least a first user selectable option for upload of pre-recorded data and a second user selectable option for upload of contemporaneous data; in response to user selection of the first option, enabling the user selection and upload of pre-recorded data to the first server, and in response to user selection of the second option, enabling the capture and upload of contemporaneous second data.

According to another aspect of the present invention, there is provided a browser application for accessing a remote network and for uploading data to a server of the network, comprising: means for interpreting mark-up data received from the network identifying a first server for data upload and for providing a first user option of uploading pre-recorded data from the memory to the first server and a second user option of capturing and uploading contemporaneous second data to the first server.

In embodiments of the invention, the contemporaneous data may be transiently stored but it is not recorded in the device.

### BRIEF DESCRIPTION OF THE DRAWINGS

For a better understanding of the present invention reference will now be made by way of example only to the accompanying drawings in which:

FIG. 1 illustrates a prior art file widget for data upload;

FIGS. 2A and 2B illustrate a system 10 for uploading an image captured by a camera 20;

FIG. 3 is a flow diagram illustrating how the browser application operates;

FIG. 4 illustrates a file widget according to an embodiment of the invention; and

FIG. 5 illustrates “Options” provided by the file widget.

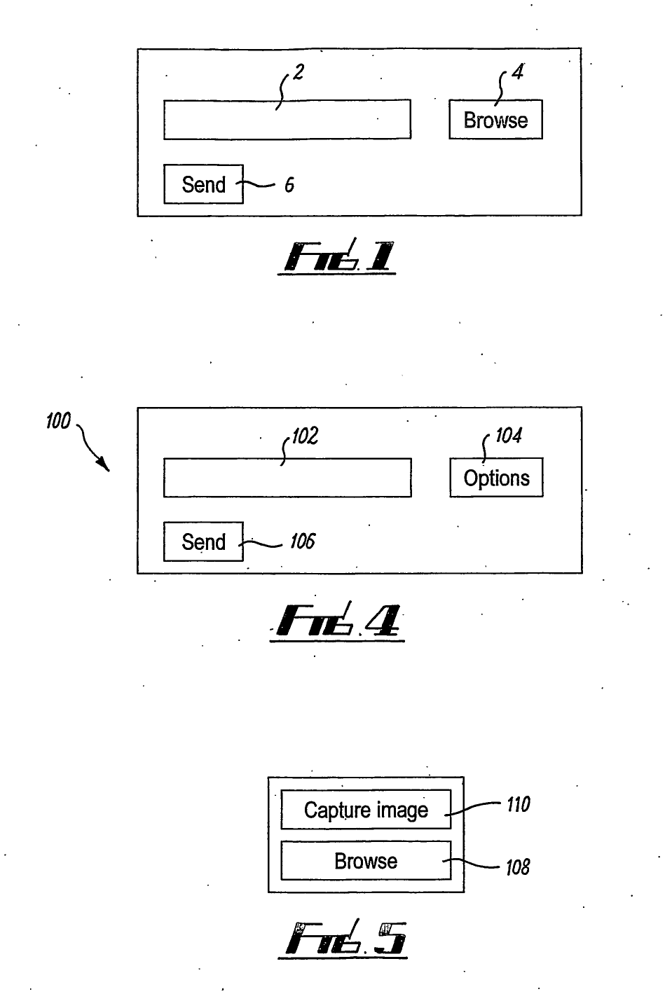

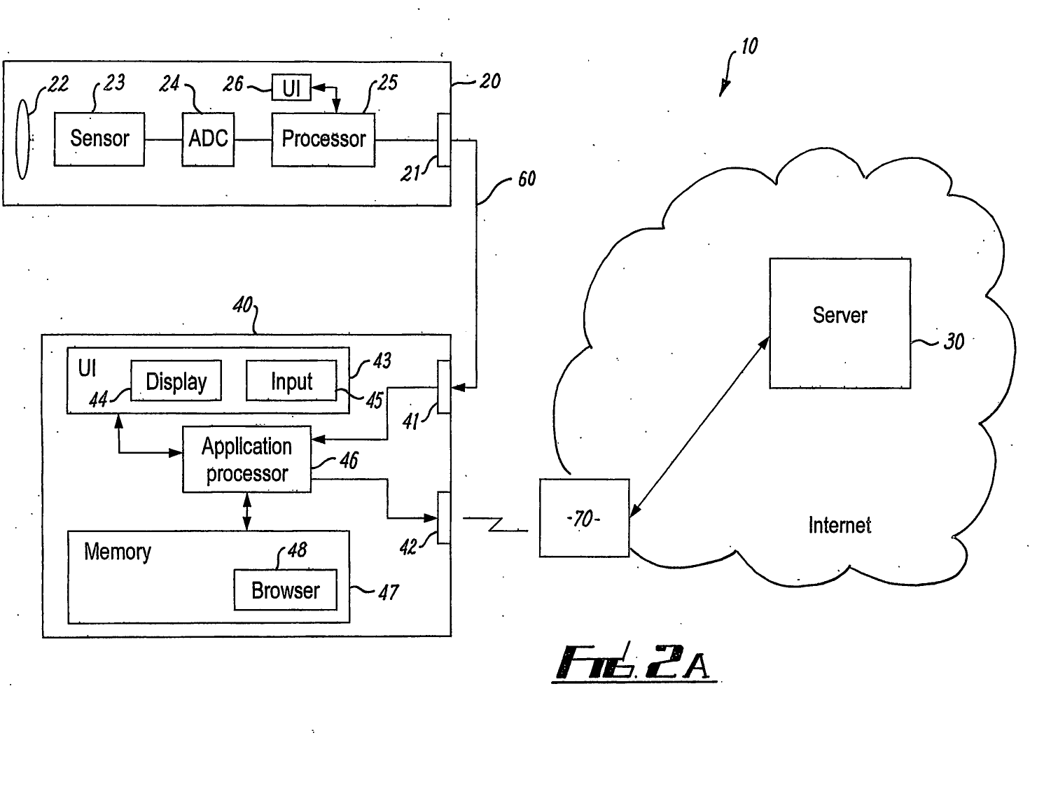

FIGS. 2A illustrates a system 10 for uploading an image captured by a camera 20 to a remote server 30. In this example, the server 30 is a part of an open network such as the internet and the client 40 uses a browser application 42 to navigate this open network.

The browser application may interpret Extensible Mark-up Language (XML) or a derivative such as Extensible Hypertext. Mark-up language (XHTML) to provide content in a graphical user interface.

In FIG. 2B, the camera 20 may be separate from the client 40 or it may be a module that is permanently or temporarily attached to the client 40. The taking of a picture using the camera 20 is controlled via the client 40 to which it is attached.

The camera module 20 has an interface 21 for communicating with the client 40, and image capturing equipment including optics 22 for focusing an image on an image sensor array 23. The output of the image sensor array is converted to digital data by an analogue to digital converter 24 and the digital data is processed by a processor 25 before being communicated across the interface 21. The camera module does not include a user interface that allows a user to take a picture. The camera module is controlled using a user interface 43 of the client 40.

The Internet access device, client 40, has an interface 41 for communicating with the camera 20, an interface 42 for communicating with the internet, a user interface 43 that includes a display 44 and a user input device 45, an application processor 46 for controlling input to, output from and the operation of the client including access to internet and a memory 47 storing a browser application 48 and camera control software 49. The application processor 46 loads browser application 48 to provide a first graphical user interface on the display 44 that enables a user to ‘surf’ the INTERNET. The application processor 46 loads camera control software 49 to provide a second graphical user interface for controlling the operation of the camera module 20 via the user input device 45.

A web-page or document on the INTERNET may be defined using XHTML or HTML. The browser 48 of the client 40 of FIGS. 2A and 2B, interprets the HTML or XHTML code to provide the first graphical interface to a user. The XHTML code, and in particular the file input object allows a user to upload a file stored on the client 20 to the server at the web address “URL” as part of a form input.

The code may for example be:

<form enctype= “multipart/form-data” method= “post” action= “URL” >
<p>
Please upload an image: <br>
<input type= “file” name= “imagefile” >
</p>
<p>
<input type= “submit” value=”send”>
</p>
</form>

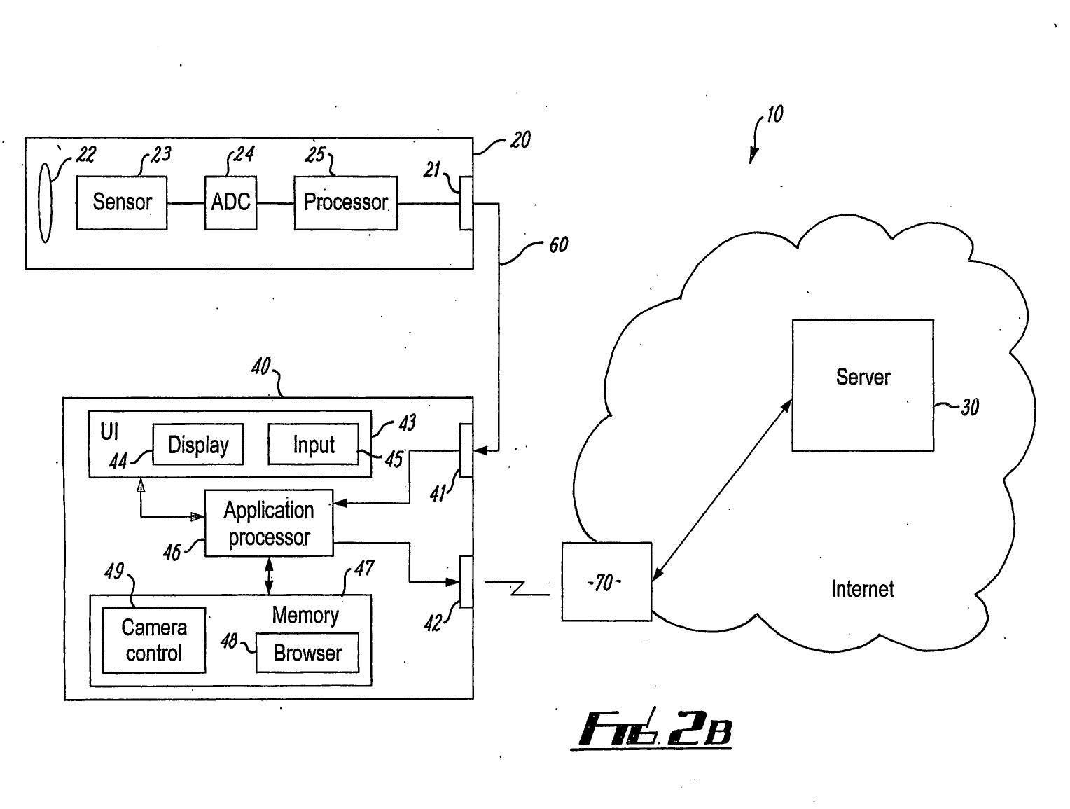

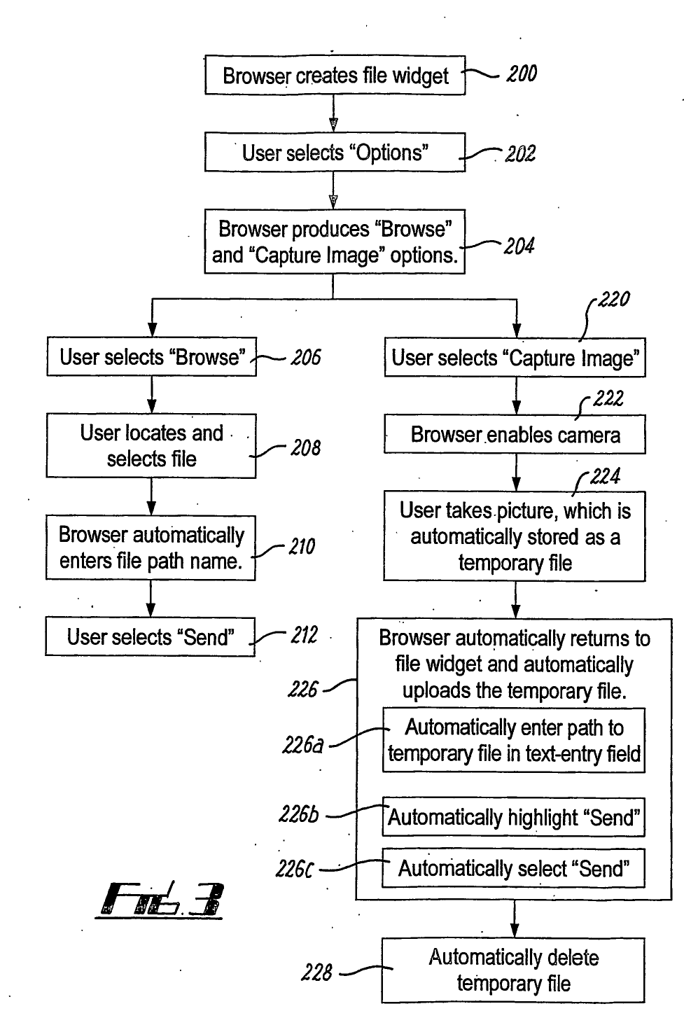

The operation of the browser is illustrated in FIG. 3. At step 200 the browser produces a file widget 100, as illustrated in FIG. 4, in its graphical user interface from the code. The file widget 100 includes a text entry field 102, an “Options” button 104 and a ‘Send’ button 106.

To upload a file from the client 40 to the server 30, the user either enters the path of the file to be uploaded in the text entry field 102 or selects, at step 202, the “Options” button 104. Selecting the “Options” button 104 at step 202 causes the browser, at step 204, to produce two user-selectable alternative options: “Browse” 108 and “Capture image” 110, as illustrated in FIG. 5.

Selecting the “Browse” option 106, at step 206, allows the user to locate and select the desired file in a file manager application at step 208, which then automatically enters the path of the selected file in the text entry field 102 at step 210. The user then selects the Send button 106, at step 212, to upload that file.

If, however, a user wishes to upload a contemporaneous image without first having to store it manually, the user selects the “Capture Image” option 108 at step 220. This provides for the easy and seamless capturing and uploading of an image to the server.

The browser application 48, at step 222, loads the camera control software 49 into the application processor 46 (if necessary) and enables the camera 20 for image capture.

At step 224, the user takes a picture, using the client's input interface 43 to capture the picture. The image can be framed using the display 44 and taken using the input device 45. The captured image is automatically stored temporarily in memory 47 at path ˜temp/imagefile.

The browser 48 returns to the first graphical user interface and displays the file widget 100 illustrated in FIG. 4 and immediately and automatically, without user input, uploads the temporarily stored image file at step 226. The step 226 is controlled by a script which performs three sub-steps. In sub-step 226a, the browser automatically enters the path name of the temporarily stored image file, ˜/temp/image, into the text entry field 102. Then, in sub-step 226b, the browser automatically highlights the “Send” button using the “tab” key input (if necessary) and in sub-step 226c automatically selects the ‘Send’ button using an ‘enter’ key input. In alternative implementations, the browser may not automatically highlight or select the “Send” button, but the user is able to do this manually.

The image stored as the temporary file ˜/temp/image is then uploaded to the server 30 identified by the web-page “URL”.

Finally, at step 228, the browser application automatically deletes the image file ˜/temp/image or allows it to be written over. The image file may be stored and deleted from memory or merely buffered in memory.

Thus embodiments of the invention enable a user to capture a contemporaneous image from within a browser application and to automatically upload it, this obviates the need for a separate procedure in which a user has to separately store the image.

FIG. 2A illustrates an alternative system 10 for uploading an image captured by a camera 20 to a remote server 30. In this embodiment the camera 20 and the client 40 are connected by a communication channel 60, which may be a physical connection or a wireless connection.

The camera 20 has an interface 21 for communicating with the client 40, and image capturing equipment including optics 22 for focusing an image on an image sensor array 23. The output of the image sensor array is converted to digital data by an analogue to digital converter 24 and the digital data is processed by a processor 25 before being communicated across the interface 21. The camera also includes a user interface 26 that allows a user to control the taking of a picture.

The internet access device, client 40 has an interface 41 for communicating with the camera 20, an interface 42 for communicating with the internet, a user interface 43 that includes a display 44 and a user input device 45, an application processor 46 for controlling input to, output from and the operation of the client including access to internet and a memory 47 storing a browser application 48. The application processor 46 loads browser application 48, provides a first graphical user interface on the display 44 and allows a user to browse the internet.

In this example, the client 40 is a mobile communications device such as a mobile telephone capable of communicating with a radio telephone network 70. The interface 42 therefore includes a radio transceiver. However, in other embodiments the client 40 may be any internet access device, such as a computer with a digital subscriber line (DSL) connection to the internet.

The alternative system 10 of FIG. 2A may operate in the same manner as described with reference to FIG. 2B, except that: at step 222, the browser application 48 enables the camera 20 for image capture by communicating with the camera via the communication channel 60 and at step 224, the user takes a picture, using the camera's user interface 26 to capture the picture. The image can be framed using a display (not shown) of the user interface 26 and taken using an input device (not shown) of the user interface 26. The captured image is transferred to the client 40 and automatically stored temporarily in memory 47 at path ˜temp/imagefile.

The alternative system may, however, additionally or alternatively operate as follows. If a user wishes to upload a contemporaneous image without first having to store it manually, the user does not select the “Capture Image” option 108 at step 220, but instead uses the user interface 26 of the camera 20 to take a picture at step 224. Thus steps 220 and 222 are jumped. The image can be framed using a display (not shown) of the user interface 26 and taken using an input device (not shown) of the user interface 26. The captured image is transferred to the client 40 and automatically stored temporarily in memory 47 at path ˜temp/imagefile.

Although the above embodiment of the invention has been described in relation to the contemporaneous capturing of an image from within a browser application, in other embodiments, other contemporaneous input from an input device such as audio data from a microphone or video from a digital video camera may be captured and automatically uploaded from within the browser.

1. A device for accessing a remote network and for uploading data to a server of the network, comprising:
an interface for communicating with the remote network;
a memory;
means for interpreting mark-up data received from the network identifying a first server for data upload and for providing a first user option of uploading pre-recorded data from the memory to the first server and a second user option of capturing and uploading contemporaneous second data to the first server.

2. A device as claimed in claim 1, further comprising a processor; a browser application; and a user interface including a display and at least one user input device, wherein the means for interpreting mark-up data is provided by the browser application running on the processor, the browser application being arranged to interpret mark-up data received from the network identifying the first server for data upload and provide via a graphical user interface on the display the first and second user options for user selection.

3. A device as claimed in claim 2, wherein the first and second user options are provided simultaneously by the browser application.

4. A device as claimed in claim 2 or 3, wherein the browser application is arranged to interpret mark-up data received from the network identifying a first server for data upload to provide a widget on the display, wherein the widget includes a user selectable option, the selection of which provides, on the display, the first and second user options for user selection.

5. A device as claimed in claims 2, wherein the browser application is arranged to respond to user selection of the first option by enabling the identification of a data file pre-recorded in the memory for upload to the first server.

6. A device as claimed in claims 2, wherein the browser application is arranged to respond to the user selection of the second option by enabling the capture of contemporaneous second data and its automatic upload to the first server.

7. A device as claimed in claims 2, wherein the browser application is stored in the memory.

8. A device as claimed in claims 2, wherein the capturing of contemporaneous data is controlled from within the browser application.

9. A device as claimed in claim 1 wherein the mark-up data received from the network identifying a first server for data upload, includes a parameter indicating the server URL.

10. A device as claimed in claim 1 wherein the mark-up data received from the network identifying a first server for data upload, includes a parameter indicating upload of data.

11. A device as claimed in claim 1 wherein the mark-up data received from the network identifying a first server for data upload, includes a parameter indicating the format in which data is to be uploaded.

12. A device as claimed in claim 1 wherein the contemporaneous data is used for upload only and is only transiently stored.

13. A device as claimed in claims 2, connected or connectable to a camera or camera module, wherein the contemporaneous second data is captured by using the user interface of the device to control the taking of a picture.

14. A device as claimed in claim 13, wherein the camera or camera module comprises a camera user interface, and the second user option is automatically chosen by taking a picture using the camera user interface.

15. A device as claimed in claim 1 wherein the network is the internet.

16. A device as claimed in claim 1, wherein the interface for communicating with the remote network includes a radio frequency transceiver.

17. A method of uploading data to a server of a network, comprising, in a browser application, the steps of:
receiving mark-up data identifying a first server for data upload;
interpreting the received mark-up data to provide at least a first user selectable option for upload of pre-recorded data and a second user selectable option for upload of contemporaneous data;
in response to user selection of the first option, enabling the user selection and upload of pre-recorded data to the first server; and
in response to user selection of the second option, enabling the capture and upload of contemporaneous second data.

18. A browser application for accessing a remote network and for uploading data to a server of the network, comprising:
means for interpreting mark-up data received from the network identifying a first server for data upload and for providing a first user option of uploading pre-recorded data from the memory to the first server and a second user option of capturing and uploading contemporaneous second data to the first server.

19. A carrier device comprising program instructions for enabling the browser application as claimed in claim 18.
